(19) United States
(12) Patent Application Publication
(10) Pub. No.: US 2018/0357603 A1
(43) Pub. Date: Dec. 13, 2018

(54) SYSTEMS AND METHODS FOR DELIVERING RETAIL ITEMS

(71) Applicant: Walmart Apollo, LLC, Bentonville, AR (US)

(72) Inventors: Bruce W. Wilkinson, Rogers, AR (US); Todd D. Mattingly, Bentonville, AR (US); Balaraman Kirthigaivasan, Bentonville, AR (US)

(21) Appl. No.: 16/001,817

(22) Filed: Jun. 6, 2018

Related U.S. Application Data
(60) Provisional application No. 62/517,356, filed on Jun. 9, 2017.

(51) Int. Cl. G06Q 10/08; G07C 5/02; G07C 5/00

(52) U.S. Cl. CPC G06Q 10/0833; G07C 5/008; G07C 5/02; G06Q 10/0832

(57) ABSTRACT

In some embodiments, apparatuses and methods are provided herein useful to delivering retail items. In some embodiments, there is provided an apparatus for delivering retail items including: a retail container configured to store one or more retail items for delivery. The retail container including: a tag reader; one or more sensors configured to provide driving events data associated with driving events during the delivery; and a control circuit coupled to the tag reader and the one or more sensors. The control circuit configured to: identify the one or more retail items based on item identifiers associated with one or more tags read by the tag reader; determine, based on item characteristics of the one or more retail items, whether the driving events during the delivery are to be evaluated; and receive the driving events data over a time period of the delivery when the driving events are to be evaluated.

### CROSS-REFERENCE TO RELATED APPLICATION

This application claims the benefit of U.S. Provisional Application No. 62/517,356, filed Jun. 9, 2017, which is incorporated herein by reference in its entirety.

### TECHNICAL FIELD

This invention relates generally to delivering retail items.

### BACKGROUND

Generally, when a retailer receives a customer order, the retailer will task a delivery agent to make a delivery to a destination associated with the customer order. The success of a delivery may largely depends on the delivery agent making the delivery.

### BRIEF DESCRIPTION OF THE DRAWINGS

Disclosed herein are embodiments of systems, apparatuses and methods pertaining to delivering retail items. This description includes drawings, wherein:

FIG. 1 illustrates a simplified block diagram of an exemplary system for delivering retail items in accordance with some embodiments;

FIG. 2 shows a flow diagram of an exemplary process of delivering retail items in accordance with some embodiments;

FIG. 3 shows a flow diagram of an exemplary process of delivering retail items in accordance with some embodiments;

FIG. 4 shows a flow diagram of an exemplary process of delivering retail items in accordance with some embodiments;

FIG. 5 shows a flow diagram of an exemplary process of delivering retail items in accordance with some embodiments;

FIG. 6 illustrates an exemplary system for use in implementing methods, techniques, devices, apparatuses, systems, servers, sources and delivering retail items, in accordance with some embodiments;

FIG. 7 comprises an illustration of blocks as configured in accordance with various embodiments of these teachings;

FIG. 8 comprises an illustration of transactions configured in accordance with various embodiments of these teachings;

FIG. 9 comprises a flow diagram in accordance with various embodiments of these teachings;

FIG. 10 comprises a process diagram as configured in accordance with various embodiments of these teachings;

FIG. 11 comprises an illustration of a delivery record configured in accordance with various embodiments of these teachings; and

FIG. 12 comprise a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for delivering retail items. In some embodiments, an apparatus for delivering retail items that includes a retail container configured to store one or more retail items for delivery by a delivery agent. By one approach, the retail container may include a tag reader that may read one or more tags associated with the one or more retail items. By another approach, the retail container may include one or more sensors configured to provide driving events data associated with driving events during the delivery of the one or more retail items. By another approach, the retail container may include a control circuit coupled to the tag reader and the one or more sensors. In one configuration, the control circuit may be configured to identify the one or more retail items based on item identifiers associated with the one or more tags read by the tag reader. In another configuration, the control circuit may determine, based on item characteristics of the one or more retail items, whether the driving events during the delivery are to be evaluated, and receive the driving events data over a time period of the delivery when the driving events are to be evaluated

In some embodiments, a method for delivering retail items, by a control circuit of a retail container configured to store one or more retail items for delivery by a delivery agent, includes identifying the one or more retail items based on item identifiers associated with one or more tags read by a tag reader of the retail container. By one approach, determining, based on item characteristics of the one or more retail items, whether driving events during the delivery of the one or more retail items are to be evaluated. By another approach, receiving driving events data from one or more sensors coupled to the control circuit over a time period of the delivery when the driving events are to be evaluated.

As such, apparatuses, systems, and/or methods described herein provide for collection of data based on one or more retail items stored in a retail container during delivery. By one approach, the collection of data may be initiated based on item characteristics of the one or more retail items. Thus, apparatuses, systems, and/or methods associated with the retail container may provide for a targeted data collection that is believed to improvement on data storage, data handling, data collection, storage space, data processing, among other improvement brought on by a targeted data collection of data, used for event investigation of a particular retail item.

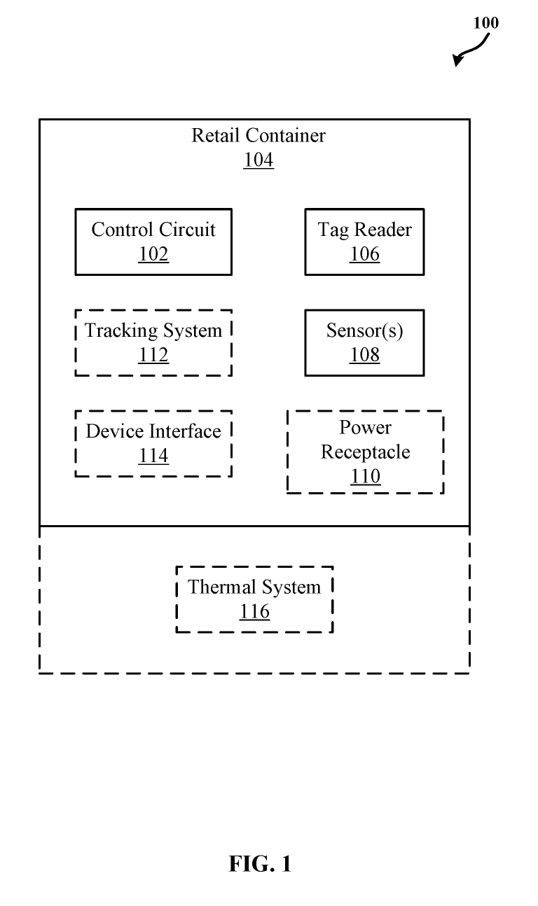

To illustrate, FIGS. 1 through 12 are described below. FIG. 1 illustrates a simplified block diagram of an exemplary system 100 for delivering retail items in accordance with some embodiments. The system 100 includes a retail container 104. By one approach, the retail container 104 may store one or more retail items for delivery by a delivery agent. In one configuration, the retail container 104 may include one or more tag readers 106. For example, the one or more tag readers 106 may comprise a bar code reader, RFID tag reader, text capture system, among other devices capable of reading identifications associated with retail items. In one implementation, the one or more tag readers 106 may be secured on and/or proximate a surface of the retail container 104. In another configuration, the retail container 104 may include one or more sensors 108 conveniently secured to the retail container 104 to detect, collect, and/or provide driving events data associated with driving events during the delivery of the one or more retail items. In one implementation, the one or more sensors 108 may comprise sound sensor, vibration sensor, acceleration sensor, speed sensor, temperature sensor, position sensor, angle sensor, displacement sensor, distance sensor, optical sensor, pressure sensor, force sensor, thermal sensor, proximity sensor, among other type of sensors capable of providing sensor data usable to determine driving events associated with retail items for delivery. In yet another configuration, the retail container may include a control circuit 102 coupled to the tag reader and the one or more sensors 108. By one approach, the control circuit 102 may be integrated with the retail container 104.

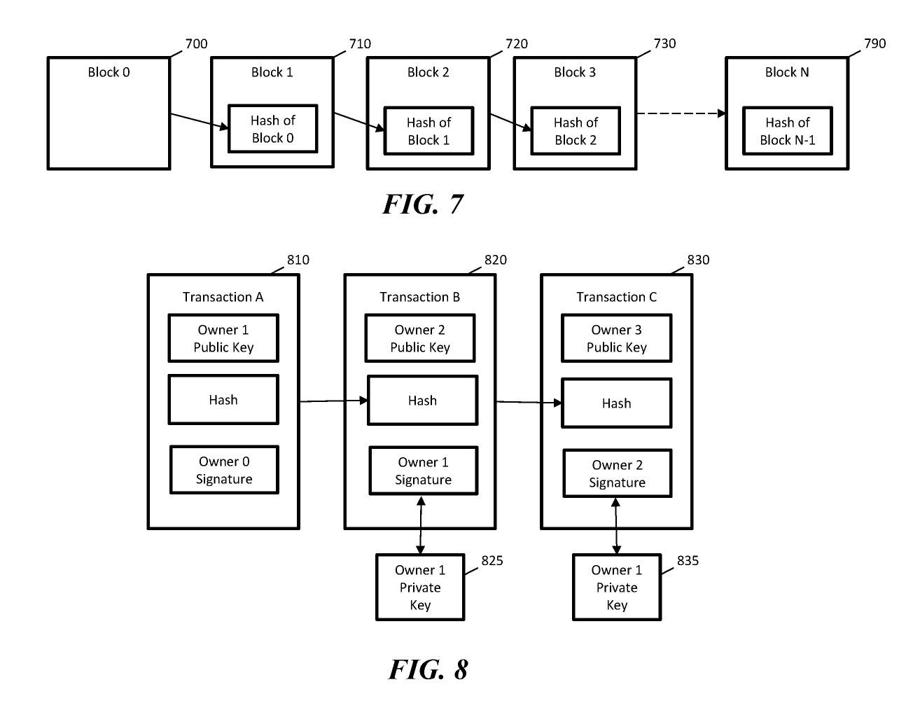

The tag reader 106 reads one or more tags associated with the one or more retail items placed in the retail container 104. For example, the tag reader 106 may read the one or more tags associated with the one or more retail items as the one or more retail items are being placed into the retail container 104. In one configuration, the one or more tags may correspond to item identifiers associated with the one or more retail items in the retail container 104. In another configuration, the corresponding item identifiers may be stored in a memory (not shown) as the one or more tags are scanned by the tag reader 106. The memory may comprise one or more volatile and/or non-volatile memories that are integrated with, locally operated with, or external to the retail container 104. For example, the retail container 104 may include the memory coupled to the control circuit 102. In another example, the memory may be detachably coupled to the retail container 104 and operatively coupled to the control circuit 102. In another example, the memory may include a cloud-based storage system. By one approach, the retail container 104 may include a device interface that may communicatively couple with at least one external device separate from the retail container 104 to enable the control circuit 102 to communicate with the at least one external device. As such, the control circuit 102 may access and/or communicate with the memory through the device interface to access information stored in the memory. Thus, the device interface may include a wireless transceiver that may wirelessly receive and transmit data with the at least one external device. The at least one external device may comprise one or more memories, one or more databases, one or more other control circuits, one or more servers, a vehicle on-board system, a user electronic device, among other devices capable of communicating wirelessly to another device. By another approach, the device interface may include wired communication interfaces capable of communicating to another devices through a physical medium. In some embodiments, the device interface may be coupled to a blockchain network. In one configuration, the control circuit 102 may be communicatively coupled to the at least one external device through the blockchain network. In such a configuration, data communications, data exchanges, and/or data transfers between the retail container 104 and the at least one external device are stored in a blockchain ledger associated with the blockchain network. For example, data may include driving events data, sensor data, data associated with retail items (e.g., item identifiers, item characteristics, etc.), and tag reader data, among other types of data that are communicated, exchanged, and/or transferred between the retail container 104 (and/or the control circuit 102) and the at least one external device during operations of the retail container 104. In another example, storing the data in the blockchain ledger may securely store the data from possible alterations, unauthorized access, and/or hacking. In another example, the data may be de-centrally stored through the blockchain network. Blockchain is further describe in paragraphs below and illustrated in FIGS. 7-12.

In another implementation, the control circuit 102 may identify the one or more retail items based on item identifiers associated with the one or more tags read by the tag reader 106. By one approach, the control circuit 102 may access at least one database of the one or more databases to identify retail items associated with the one or more tags. In one configuration, the database may include a plurality of retail items and/or item characteristics associated with the plurality of retail items. Thus, the control circuit 102 may access at least one database of the one or more databases to determine item characteristics associated with the one or more retail items stored in the retail container 104. By one approach, the control circuit 102 may parse through the determined item characteristics. In such an approach, the control circuit 102 may determine which one of the one or more retail items have item characteristics that match with one or more triggers. By one approach, the one or more triggers may correspond to predetermined words stored in the memory. In one example, the predetermined words may be words that may trigger to initiate data collection of driving events. As such, the control circuit 102 may determine that the driving events during a delivery are to be evaluated. For example, the one or more triggers may comprise fragile, perishable, temperature sensitive, time sensitive, among other words that may indicate that an occurrence of one or more driving events during a delivery may affect usage, functionality, and/or quality of the one or more retail items at the time of delivery to a customer. Thus, the control circuit 102 may determine, based on the item characteristics of the one or more retail items, whether the driving events during the delivery are to be evaluated. For example, upon the determination that there is at least a match of one of the item characteristics with at least one of the one or more triggers, the control circuit 102 may determine that the driving events during the delivery are to be evaluated. In another example, the control circuit 102 may determine that the driving events associated with a particular retail item of the one or more retail items may be evaluated based on the determined match. For example, the retail container 104 may store a can of creamy corn and a jar of sliced peaches for delivery by a delivery agent. In accessing the database, the control circuit 102 may determine that at least one item characteristic associated with the jar of sliced peaches may correspond to breakable. By one approach, the control circuit 102 may determine that the item characteristic of breakable matches, within a threshold value, one of the one or more triggers. In response, the control circuit 102 may determine that the driving events are to be evaluated based on the determination that the item characteristic matched within the threshold value the one of the one or more triggers. Thus, the control circuit 102 may activate at least one of the sensor(s) 108 based on the determination that the driving events are to be evaluated. In another approach, the control circuit 102 may selectively activate at least one sensor of the sensor(s) 108 that is particularly associated with a retail item having an item characteristic that matches with a trigger. For example, the control circuit 102 may determine that the can of creamy corn does not have item characteristics that match with the triggers. However, the control circuit 102 may have determined that the jar of sliced peaches has an item characteristic that matches with one of the triggers. As such, the control circuit 102 may selectively activate at least one sensor associated with the jar of sliced peaches, for example, a motion sensor temporarily cooperated with the jar of sliced peaches such as in some reusable protective packaging. Thus, the at least one sensor associated with the jar of sliced peaches may provide driving events data. In such an example, the control circuit 102 may evaluate driving events associated with the jar of sliced peaches based on the driving events data received from the at least one sensor that is associated with the jar of sliced peaches.

In one configuration, the control circuit 102 may receive driving events data over a time period of a delivery when the driving events are to be evaluated. By one approach, the control circuit 102 may activate the sensor(s) 108. In such an approach, the sensor(s) 108 may provide driving events data over the time period. In one implementation, at least one sensor of the sensor(s) 108 may include a sensor that may measure at least one of acceleration or vibration of at least one of: the retail container 104 or the one or more retail items. In another implementation, the driving events data may include measured data of the sensor(s) 108 and/or sensor data provided by the sensor(s) 108. By one approach, the control circuit 102 may disable the sensor(s) 108 from measuring at least one of acceleration or vibration in response to a determination that driving events during a delivery are not to be evaluated. For example, the control circuit 102 may determine that none of the item characteristics associated with the one or more retail items of the retail container 104 has a match with one or more triggers. As such, the control circuit 102 may disable the sensor(s) 108. By another approach, the control circuit 102 may keep the sensor(s) 108 deactivated. Thus, the control circuit 102 may not perform data collection of driving events during a delivery when the item characteristics of the one or more retail items do not match with at least one of the triggers.

By one approach, the control circuit 102 may initiate storage of the driving events data in the memory. In one configuration, the control circuit 102 may initiate storage of the driving events data based on the determination that the driving events are to be evaluated. For example, continuing the illustrative non-limiting example above, in response to determining that the driving events data are to be evaluated based on the jar of sliced peaches, the control circuit 102 may provide a signal to the memory to start storing the driving events data provided by the sensor(s) 108. Thus, basing data collection of driving events on item characteristics of retail items in the retail container 104 provides at least in part a benefit of efficiently using memory storage space of the memory.

By one approach, the control circuit 102 may determine whether the driving events data has reached one or more event thresholds. In one configuration, the one or more event thresholds may each correspond to a respective one of the item characteristics of the one or more retail items. For example, continuing the illustrative non-limiting example above, the sensor(s) 108 that may provide driving events data, for example, may comprise sound sensor, optical sensor, speed sensor, and/or accelerometer. In one configuration, each of the sensor(s) 108 may be associated with at least one event threshold. For example, a first event threshold associated with the sound sensor may correspond to a threshold frequency. In one scenario, the threshold frequency may correspond to a frequency of sound of glass breakage. In another example, a second event threshold associated with the speed sensor may correspond to a threshold speed. In another scenario, the threshold speed may correspond to a predetermined speed that is associated with higher likelihood of a retail item falling off a shelf in the delivery truck and/or a higher likelihood that one retail item may hit another retail item in proximity. In another example, a third event threshold associated with the optical sensor may correspond to a threshold movement. In one scenario, the threshold movement may correspond to whether the optical sensor detected movement of a retail item. As such, in the database, the item characteristic of breakable may be associated with the jar of sliced peaches and/or the speed, sound, and optical sensors. Thus, in accessing the database, the control circuit 102 may determine that the item characteristic of breakable may be associated with the sound sensor, the optical sensor, and/or the speed sensor. Alternatively or in addition to, the control circuit 102 may determine that the jar of sliced peaches may be have an item characteristic associated with breakable. Thus, when the jar of sliced peaches broke half-way to a two (2) hour delivery, the driving events data corresponding to each of the optical, speed, and sound sensors may reach, based on the determination of the control circuit 102, the third event threshold, second event threshold, and the first event threshold, respectively. For example, the first event threshold may have been reached when the sound sensor provided driving events data corresponding to a glass breakage. By one approach, the control circuit 102 may cause one or more alert messages to be communicated to the delivery agent based on the determination that the driving events data has reached at least one of the first, second, and third event thresholds. In one example, the one or more alert messages may comprise a data message to be displayed on a display device visible to the delivery agent (e.g., the data message may include slow down) and/or a video message based on, for example, the driving events data of the sound sensor, among other messages that may notify the delivery agent of status of the one or more retail items. By another approach, the control circuit 102 may associate each of the driving events data that reached the one or more event thresholds with the driving events relative to the time period. For example, the control circuit 102 may perform signal processing of the driving events data to correlate the driving events data with the driving events relative to the time period of the delivery. In response, the control circuit 102 may display in a graphical format the resulting correlation between the driving events data and the driving events relative to the time period of the delivery.

In one configuration, a first sensor of the one or more sensors 108 may provide a container open data to the control circuit 102 in response to an opening of the retail container 104. By one approach, the driving events data may include the container open data. In another configuration, during a particular time of the delivery, the control circuit 102 may receive the driving events data indicating the opening of the retail container 104. In one implementation, subsequent to the receipt of the driving events data, the control circuit 102 may determine during the particular time a location of the delivery vehicle via a Global Positioning System (GPS) system of the retail container 104. By one approach, the control circuit 102 may determine whether the delivery vehicle performed an unscheduled stop at an unscheduled stop location during the delivery of the one or more retail items by comparing the location of the delivery vehicle during the particular time with delivery destinations associated with the one or more retail items. Thus, the control circuit 102 may correlate the driving events data (e.g., the container open data indicating the opening of the retail container 104) with the driving events (e.g., the unscheduled stop at the unscheduled stop location) during the particular time of the delivery.

By another approach, the control circuit 102 may receive subsequent reads of the one or more tags from the tag reader 106 in response to receiving the container open data during the unscheduled stop. Alternatively or in addition to, the control circuit 102 may determine whether at least one of the one or more retail items have been tampered with based on the unscheduled stop location and based on the subsequent read of the one or more tags. For example, the control circuit 102 may determine that the delivery vehicle made an unscheduled stop based on the location of the delivery vehicle during the particular time of the delivery not matching with one of the delivery destinations associated with the one or more retail items. In response, the control circuit 102 may send a signal to the tag reader 106 to read the one or more tags of the one or more retail items of the retail container 104. Alternatively or in addition to, the control circuit 102 may receive the one or more tags without sending the signal to the tag reader 106. In one configuration, the control circuit 102 may compare a most recent read of the one or more tags prior to the unscheduled stop with the one or more tags read during the unscheduled stop and/or after the opening of the retail container 104. In response, when there is a match of the most recent read with the one or more tags read during the unscheduled stop and/or after the opening of the retail container 104, the control circuit 102 may determine that there is no tampering of the one or more retail items. However, when there is not a match of the most recent read with the one or more tags read during the unscheduled stop and/or after the opening of the retail container 104, the control circuit 102 may determine that there is tampering of the one or more retail items. In response, the control circuit 102 may send a message to an electronic device associated with a retailer and/or an associate indicating that the one or more retail items may have been tampered.

In some embodiments, the retail container 104 may include a tracking system 112 that may provide locational data to the control circuit 102. By one approach, the tracking system 112 may include the GPS system. Thus, the control circuit 102 may determine the driving events based at least on the locational data. For example, in the illustrative non-limiting example above, the control circuit 102 may determine that the delivery vehicle made the unscheduled stop (e.g., the driving events) based on the comparison of the locational data of the unscheduled stop with the delivery destinations associated with the one or more retail items. As such, the control circuit 102 may determine whether a deviation from at least one predetermined delivery route associated with the one or more retail items may have occurred based on the driving events. By one approach, the control circuit 102 may provide a message to the electronic device associated with the retailer and/or the associate indicating that the delivery vehicle has deviated from the at least one predetermined delivery route.

In some embodiments, the retail container 104 may include a thermal system 116 that may be coupled with the control circuit 102. The thermal system 116 may provide at least one of heating or cooling of the one or more retail items. By one approach, the control circuit 102 may communicate with and/or operate the thermal system 116 to cause an adjustment to a temperature of the retail container 104. For example, the control circuit 102 may determine that the temperature of the retail container 104 may be at a value outside a temperature range associated with an industry storage standard and/or a predetermined storage standard associated with the one or more retail times. As such, the control circuit 102 may adjust the temperature to be at a value of the temperature range through the thermal system 116.

In yet some embodiments, the retail container 104 may include a power receptacle 110 having a transformer that may receive power from the delivery vehicle upon securing the retail container 104 to the delivery vehicle. For example, the power receptacle 110 may be operatively coupled with the control circuit 102. By one approach, the control circuit 102 may initiate charging a battery associated with the retail container 104 upon a determination that the retail container 104 is secured to the delivery vehicle. By another approach, the control circuit 102 may determine that the retail container 104 is secured to the delivery vehicle when there is electrical conductivity at the power receptacle 110. In one configuration, the control circuit 102 may use the power from the delivery vehicle to power the retail container 104. In another configuration, the power from the battery may be configured by the control circuit 102 to be a secondary source of power to the retail container 104.

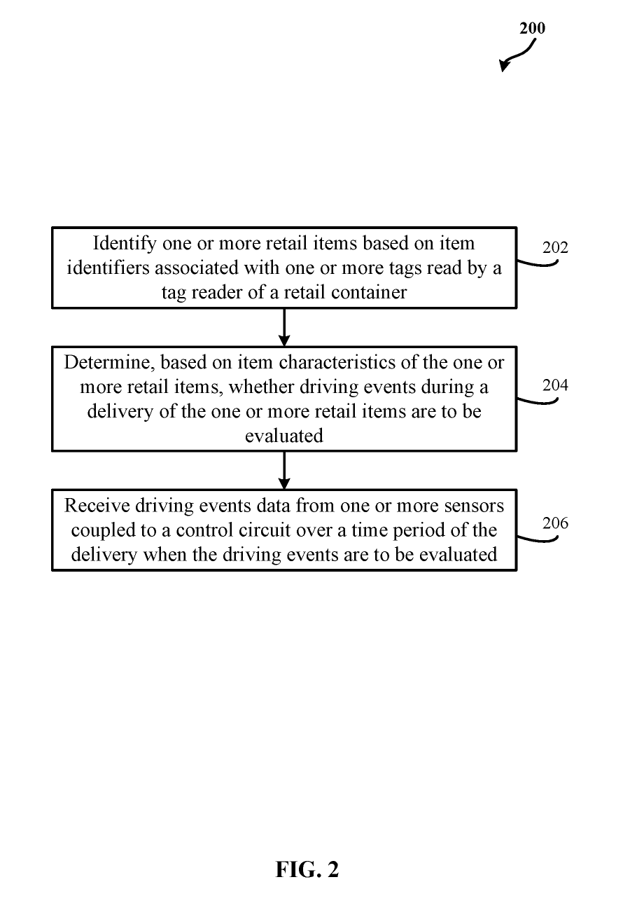

FIG. 2 illustrates a flow diagram of an exemplary method 200 for delivering retail items. The exemplary method 200 may be implemented in the system 100 of FIG. 1. By one approach, the method 200 may be implemented in the control circuit 102 of FIG. 1. The method 200 includes, at step 202, identifying the one or more retail items based on item identifiers associated with one or more tags read by a tag reader of the retail container. The method 200 may include determining, based on item characteristics of the one or more retail items, whether driving events during the delivery of the one or more retail items are to be evaluated, at step 204. By one approach, the method 200 may include, at step 206, receiving driving events data from one or more sensors coupled to the control circuit over a time period of the delivery when the driving events are to be evaluated.

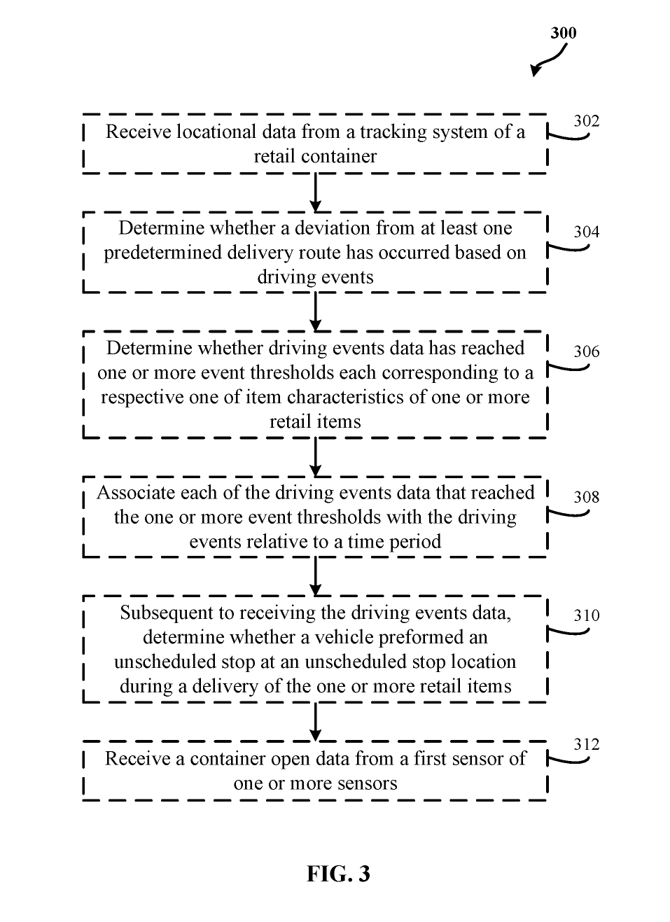

FIG. 3 illustrates a flow diagram of an exemplary method 300 for delivering retail items. The exemplary method 300 may be implemented in the system 100 of FIG. 1. By one approach, the method 300 may be implemented in the control circuit 102 of FIG. 1. By another approach, the method 300 and/or one or more steps of the method may optionally be included in and/or performed in cooperation with the method 200 of FIG. 2. The method 300 may include, at step 302, receiving locational data from a tracking system of the retail container. In one configuration, the method 300 may include, at step 304, determining whether a deviation from at least one predetermined delivery route has occurred based on the driving events. By one approach, method 300 may include determining whether the driving events data has reached one or more event thresholds each corresponding to a respective one of the item characteristics of the one or more retail items, at step 306. In one configuration, the method 300 may include, at step 308, associating each of the driving events data that reached the one or more event thresholds with the driving events relative to the time period. By yet another approach, the method 300 may include, at step 310, subsequent to the receiving of the driving events data, determining whether the vehicle preformed an unscheduled stop at an unscheduled stop location during the delivery of the one or more retail items, wherein the driving events comprise the unscheduled stop. In one configuration, the method 300 may include receiving a container open data from a first sensor of the one or more sensors, at step 312. In such a configuration, the driving events data may include the container open data.

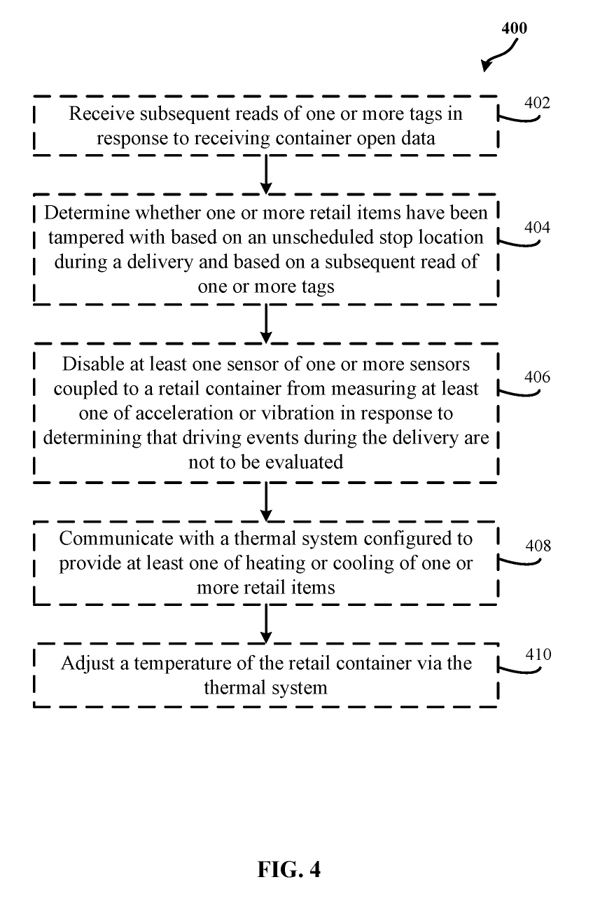

FIG. 4 illustrates a flow diagram of an exemplary method 400 for delivering retail items. The exemplary method 400 may be implemented in the system 100 of FIG. 1. By one approach, the method 400 may be implemented in the control circuit 102 of FIG. 1. By another approach, the method 400 and/or one or more steps of the method may optionally be included in and/or performed in cooperation with the method 200 of FIG. 2 and/or the method 300 of FIG. 3. The method 400 may include, at step 402, receiving subsequent reads of the one or more tags in response to the receiving of the container open data. In one configuration, the method 400 may include, at step 404, determining whether the one or more retail items have been tampered with based on the unscheduled stop location during the delivery and based on the subsequent read of the one or more tags. By one approach, the method 400 may include, at step 406, disabling at least one sensor of the one or more sensors coupled to the retail container from measuring the at least one of acceleration or vibration in response to the determining that the driving events during the delivery are not to be evaluated. By another approach, the method 400 may include, at step 408, communicating with a thermal system configured to provide at least one of heating or cooling of the one or more retail items. By another approach, the method 400 may include adjusting a temperature of the retail container via the thermal system, at step 410.

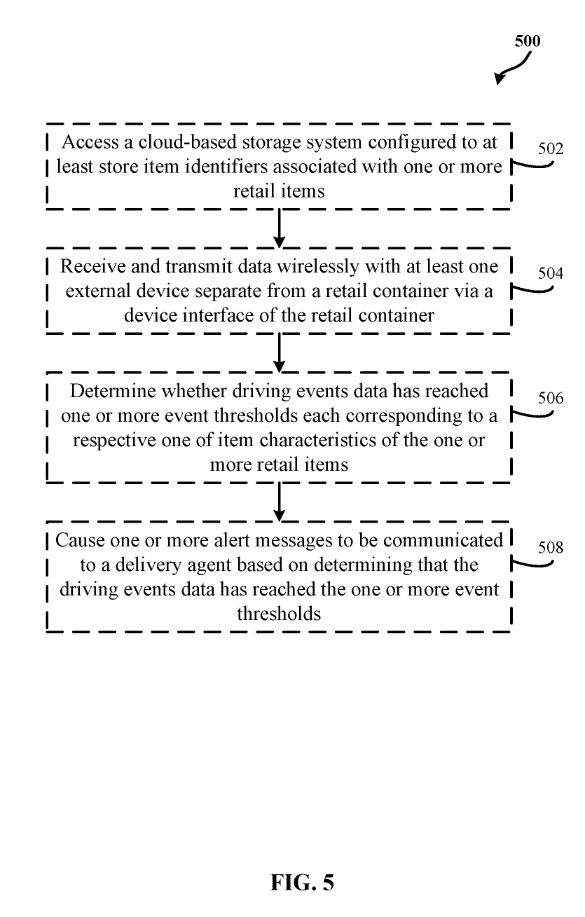

FIG. 5 illustrates a flow diagram of an exemplary method 400 for delivering retail items. The exemplary method 500 may be implemented in the system 100 of FIG. 1. By one approach, the method 500 may be implemented in the control circuit 102 of FIG. 1. By another approach, the method 500 and/or one or more steps of the method may optionally be included in and/or performed in cooperation with the method 200 of FIG. 2, the method 300 of FIG. 3, and/or the method 400 of FIG. 4. The method 500 may include, at step 502, accessing a cloud-based storage system configured to at least store item identifiers associated with the one or more retail items. By one approach, the method 500 may include receiving and transmitting data wirelessly with at least one external device separate from the retail container via a device interface of the retail container, at step 504. By another approach, the method 500 may include, at step 506, determining whether the driving events data has reached one or more event thresholds each corresponding to a respective one of the item characteristics of the one or more retail items. In one configuration, the method 500 may include, at step 508, causing one or more alert messages to be communicated to the delivery agent based on the determining that the driving events data has reached the one or more event thresholds.

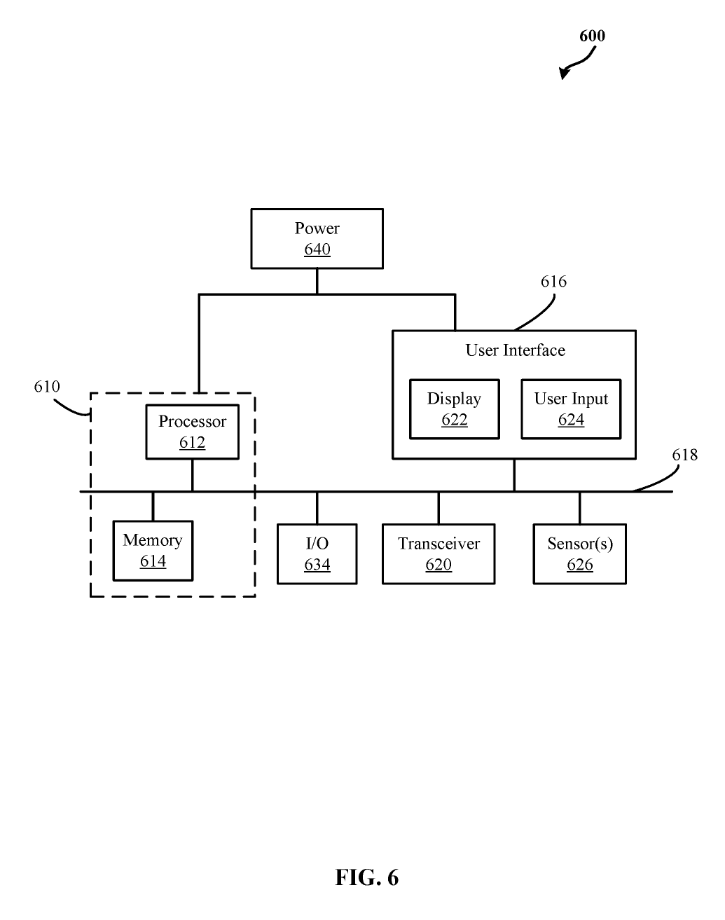

Further, the circuits, circuitry, systems, devices, processes, methods, techniques, functionality, services, servers, sources and the like described herein may be utilized, implemented and/or run on many different types of devices and/or systems. FIG. 6 illustrates an exemplary system 600 that may be used for implementing any of the components, circuits, circuitry, systems, functionality, apparatuses, processes, or devices of the system 100 of FIG. 1, the method 200 of FIG. 2, the method 300 of FIG. 3, the method 400 of FIG. 4, the method 500 of FIG. 5, and/or other above or below mentioned systems or devices, or parts of such circuits, circuitry, functionality, systems, apparatuses, processes, or devices. For example, the system 500 may be used to implement some or all of the system 100 for delivering retail items, the retail container 104, the tag reader 106, the sensor(s) 108, the power receptacle 110, the tracking system 112, the device interface 114, the thermal system 116, and/or other such components, circuitry, functionality and/or devices. However, the use of the system 600 or any portion thereof is certainly not required.

By way of example, the system 600 may comprise a processor module (or a control circuit) 612, memory 614, and one or more communication links, paths, buses or the like 618. Some embodiments may include one or more user interfaces 616, and/or one or more internal and/or external power sources or supplies 640. The control circuit 612 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 612 can be part of control circuitry and/or a control system 610, which may be implemented through one or more processors with access to one or more memory 614 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 600 may be used to implement one or more of the above or below, or parts of, components, circuits, systems, processes and the like. For example, the system 600 may implement the system 100 for delivering retail items with the control circuit 102 being the control circuit 612.

The user interface 616 can allow a user to interact with the system 600 and receive information through the system. In some instances, the user interface 616 includes a display 622 and/or one or more user inputs 624, such as buttons, touch screen, track ball, keyboard, mouse, etc., which can be part of or wired or wirelessly coupled with the system 600. Typically, the system 600 further includes one or more communication interfaces, ports, transceivers 620 and the like allowing the system 600 to communicate over a communication bus, a distributed computer and/or communication network (e.g., a local area network (LAN), the Internet, wide area network (WAN), etc.), communication link 618, other networks or communication channels with other devices and/or other such communications or combination of two or more of such communication methods. Further the transceiver 620 can be configured for wired, wireless, optical, fiber optical cable, satellite, or other such communication configurations or combinations of two or more of such communications. Some embodiments include one or more input/output (I/O) interface 634 that allow one or more devices to couple with the system 600. The I/O interface can be substantially any relevant port or combinations of ports, such as but not limited to USB, Ethernet, or other such ports. The I/O interface 634 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 626 to provide information to the system and/or sensor information that is communicated to another component, such as the central control system, a portable retail container, a vehicle associated with the portable retail container, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 600 comprises an example of a control and/or processor-based system with the control circuit 612. Again, the control circuit 612 can be implemented through one or more processors, controllers, central processing units, logic, software and the like. Further, in some implementations the control circuit 612 may provide multiprocessor functionality.

The memory 614, which can be accessed by the control circuit 612, typically includes one or more processor readable and/or computer readable media accessed by at least the control circuit 612, and can include volatile and/or nonvolatile media, such as RAM, ROM, EEPROM, flash memory and/or other memory technology. Further, the memory 614 is shown as internal to the control system 610; however, the memory 614 can be internal, external or a combination of internal and external memory. Similarly, some or all of the memory 614 can be internal, external or a combination of internal and external memory of the control circuit 612. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 614 can store code, software, executables, scripts, data, content, lists, programming, programs, log or history data, user information, customer information, product information, and the like. While FIG. 6 illustrates the various components being coupled together via a bus, it is understood that the various components may actually be coupled to the control circuit and/or one or more other components directly.

Descriptions of some embodiments of blockchain technology are provided with reference to FIG. 7-12 herein. In some embodiments of the invention described above, blockchain technology may be utilized to record driving events data, sensor data, data associated with retail items (e.g., item identifiers, item characteristics, etc.), tag reader data, data communications, data exchanges, and/or data transfers between the retail container 104 and the at least one external device, etc. One or more of the retail container 104, the control circuit 102, and/or the at least one external device (memories, databases, other control circuits, servers, a vehicle on-board system, user electronic devices, etc. described herein may comprise a node in a distributed blockchain system storing a copy of the blockchain record. Updates to the blockchain may comprise data communications, data exchanges, and/or data transfers between the retail container 104 and the at least one external device and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 7, an illustration of a blockchain according to some embodiments is shown. In some embodiments, a blockchain comprises a hash chain or a hash tree in which each block added in the chain contains a hash of the previous block. In FIG. 7, block 0 700 represents a genesis block of the chain. Block 1 710 contains a hash of block 0 700, block 2 720 contains a hash of block 1 710, block 3 730 contains a hash of block 2 720, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

Now referring to FIG. 8, an illustration of blockchain based transactions according to some embodiments is shown. In some embodiments, the blockchain illustrated in FIG. 8 comprises a hash chain protected by private/public key encryption. Transaction A 810 represents a transaction recorded in a block of a blockchain showing that owner 1 (recipient) obtained an asset from owner 0 (sender). Transaction A 810 contains owner's 1 public key and owner 0's signature for the transaction and a hash of a previous block. When owner 1 transfers the asset to owner 2, a block containing transaction B 820 is formed. The record of transaction B 820 comprises the public key of owner 2 (recipient), a hash of the previous block, and owner 1's signature for the transaction that is signed with the owner 1's private key 825 and verified using owner 1's public key in transaction A 810. When owner 2 transfers the asset to owner 3, a block containing transaction C 830 is formed. The record of transaction C 830 comprises the public key of owner 3 (recipient), a hash of the previous block, and owner 2's signature for the transaction that is signed by owner 2's private key 835 and verified using owner 2's public key from transaction B 820. In some embodiments, when each transaction record is created, the system may check previous transaction records and the current owner's private and public key signature to determine whether the transaction is valid. In some embodiments, transactions are being broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 8 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

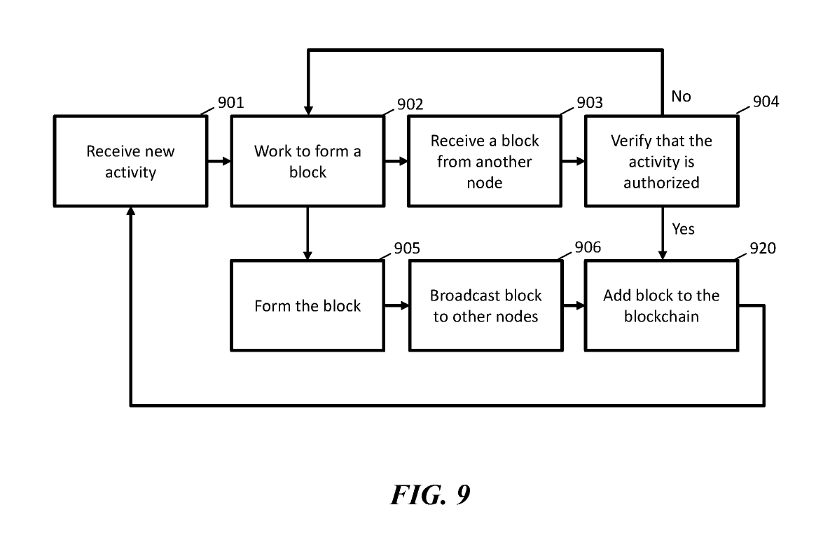

Now referring to FIG. 9, a flow diagram according to some embodiments is shown. In some embodiments, the steps shown in FIG. 9 may be performed by a processor-based device, such as a computer system, a server, a distributed server, a timestamp server, a blockchain node, and the like. In some embodiments, the steps in FIG. 9 may be performed by one or more of the nodes in a system using blockchain for record keeping.

In step 901, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 901. In step 902, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 902, if the node successfully forms a block in step 905 prior to receiving a block from another node, the node broadcasts the block to other nodes over the network in step 906. In some embodiments, in a system with incentive features, the first node to form a block may be permitted to add incentive payment to itself in the newly formed block. In step 920, the node then adds the block to its copy of the blockchain. In the event that the node receives a block formed by another node in step 903 prior to being able to form the block, the node works to verify that the activity recorded in the received block is authorized in step 904. In some embodiments, the node may further check the new block against system consensus rules for blocks and activities to verify whether the block is properly formed. If the new block is not authorized, the node may reject the block update and return to step 902 to continue to work to form the block. If the new block is verified by the node, the node may express its approval by adding the received block to its copy of the blockchain in step 920. After a block is added, the node then returns to step 901 to form the next block using the newly extended blockchain for the hash in the new block.

In some embodiments, in the event one or more blocks having the same block number is received after step 920, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 901.

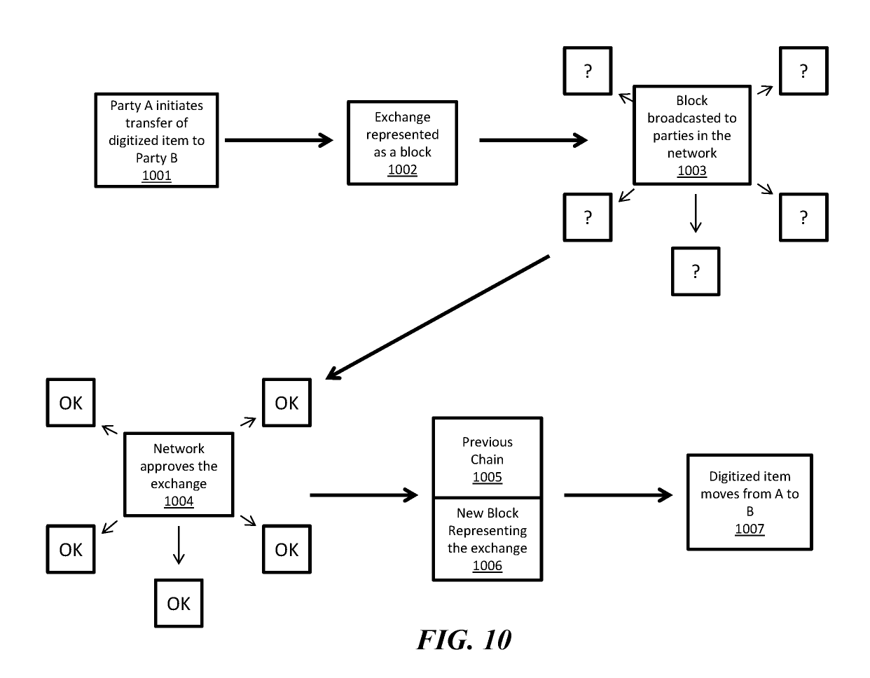

Now referring to FIG. 10, a process diagram a blockchain update according to some implementations in shown. In step 1001, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 1002, the exchange initiated in step 1001 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 1003, the block is broadcasted to parties in the network. In step 1004, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 1006 representing the exchange is added to the existing chain 1005 comprising blocks that chronologically precede the new block 1006. The new block 1006 may contain the transaction(s) and a hash of one or more blocks in the existing chain 1005. In some embodiments, each node may then update their copy of the blockchain with the new block and continue to work on extending the chain with additional transactions. In step 1007, when the chain is updated with the new block, the digitized item is moved from party A to party B.

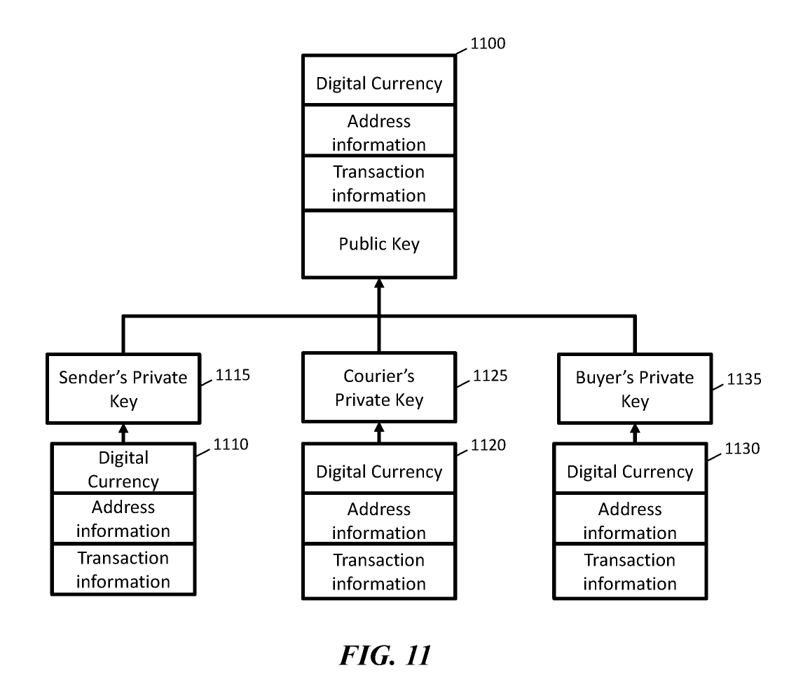

Now referring to FIG. 11, a diagram of a blockchain according to some embodiments in shown. FIG. 11 comprises an example of an implementation of a blockchain system for delivery service record keeping. The delivery record 1100 comprises digital currency information, address information, transaction information, and a public key associated with one or more of a sender, a courier, and a buyer. In some embodiments, nodes associated the sender, the courier, and the buyer may each store a copy of the delivery record 1110, 1120, and 1130 respectively. In some embodiments, the delivery record 1100 comprises a public key that allows the sender, the courier, and/or the buyer to view and/or update the delivery record 1100 using their private keys 1115, 1125, and the 1135 respectively. For example, when a package is transferred from a sender to the courier, the sender may use the sender's private key 1115 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 1125 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 11, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

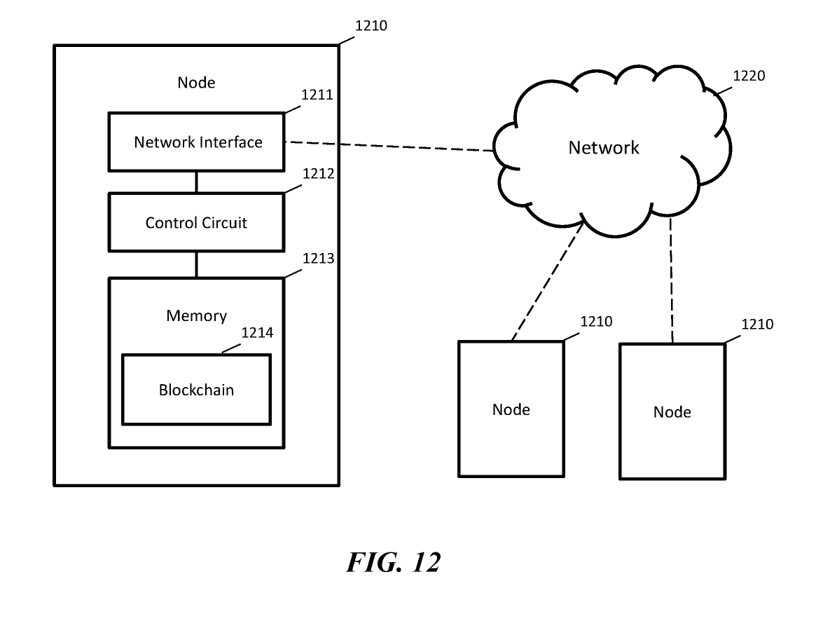

Now referring to FIG. 12, a system according to some embodiments is shown. A distributed blockchain system comprises a plurality of nodes 1210 communicating over a network 1220. In some embodiments, the nodes 1210 may be comprise a distributed blockchain server and/or a distributed timestamp server. In some embodiments, one or more nodes 1210 may comprise or be similar to a “miner” device on the Bitcoin network. Each node 1210 in the system comprises a network interface 1211, a control circuit 1212, and a memory 1213.

The control circuit 1212 may comprise a processor, a microprocessor, and the like and may be configured to execute computer readable instructions stored on a computer readable storage memory 1213. The computer readable storage memory may comprise volatile and/or non-volatile memory and have stored upon it a set of computer readable instructions which, when executed by the control circuit 1212, causes the node 1210 update the blockchain 1214 stored in the memory 1213 based on communications with other nodes 1210 over the network 1220. In some embodiments, the control circuit 1212 may further be configured to extend the blockchain 1214 by processing updates to form new blocks for the blockchain 1214. Generally, each node may store a version of the blockchain 1214, and together, may form a distributed database. In some embodiments, each node 1210 may be configured to perform one or more steps described with reference to FIGS. 9-10 herein.

The network interface 1211 may comprise one or more network devices configured to allow the control circuit to receive and transmit information via the network 1220. In some embodiments, the network interface 1211 may comprise one or more of a network adapter, a modem, a router, a data port, a transceiver, and the like. The network 1220 may comprise a communication network configured to allow one or more nodes 1210 to exchange data. In some embodiments, the network 1220 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An apparatus for delivering retail items comprising:
a retail container configured to store one or more retail items for delivery by a delivery agent, the retail container comprising:
a tag reader configured to read one or more tags associated with the one or more retail items;
one or more sensors configured to provide driving events data associated with driving events during the delivery of the one or more retail items; and
a control circuit coupled to the tag reader and the one or more sensors, the control circuit configured to:
identify the one or more retail items based on item identifiers associated with the one or more tags read by the tag reader;
determine, based on item characteristics of the one or more retail items, whether the driving events during the delivery are to be evaluated; and
receive the driving events data over a time period of the delivery when the driving events are to be evaluated.

2. The apparatus of claim 1, wherein the retail container further comprises a tracking system configured to provide locational data to the control circuit, and wherein the control circuit is further configured to determine the driving events based at least on the locational data.

3. The apparatus of claim 2, wherein the control circuit is further configured to determine whether a deviation from at least one predetermined delivery route has occurred based on the driving events.

4. The apparatus of claim 1, wherein the control circuit is further configured to:
determine whether the driving events data has reached one or more event thresholds each corresponding to a respective one of the item characteristics of the one or more retail items; and
associate each of the driving events data that reached the one or more event thresholds with the driving events relative to the time period.

5. The apparatus of claim 1, wherein a first sensor of the one or more sensors is configured to provide a container open data to the control circuit in response to an opening of the retail container, wherein the driving events data comprises the container open data, and wherein the control circuit is further configured to:
subsequent to the receipt of the driving events data, determine whether a vehicle performed an unscheduled stop at an unscheduled stop location during the delivery of the one or more retail items, wherein the driving events comprise the unscheduled stop;
receive subsequent reads of the one or more tags in response to receiving the container open data during the unscheduled stop; and
determine whether at least one of the one or more retail items have been tampered with based on the unscheduled stop location and based on the subsequent read of the one or more tags.

6. The apparatus of claim 1, wherein at least one sensor of the one or more sensors is configured to measure at least one of acceleration or vibration of at least one of: the retail container or the one or more retail items, wherein the driving events data comprises the measured data of the at least one sensor, and wherein the control circuit is further configured to disable the at least one sensor from measuring the at least one of acceleration or vibration in response to the determination that the driving events during the delivery are not to be evaluated.

7. The apparatus of claim 1, wherein the retail container further comprises a device interface configured to communicatively couple with at least one external device separate from the retail container to enable the control circuit to communicate with the at least one external device.

8. The apparatus of claim 7, wherein the device interface comprises a wireless transceiver configured to wirelessly receive and transmit data with the at least one external device.

9. The apparatus of claim 1, further comprising a thermal system configured to provide at least one of heating or cooling of the one or more retail items, wherein the control circuit is further configured to communicate with the thermal system and cause an adjustment to a temperature of the retail container via the thermal system.

10. The apparatus of claim 1, wherein the retail container further comprises a power receptacle having a transformer that is configured to receive power from the vehicle upon securing the retail container to the vehicle.

11. The apparatus of claim 1, wherein the control circuit is further configured to:
determine whether the driving events data has reached one or more event thresholds each corresponding to a respective one of the item characteristics of the one or more retail items; and
cause one or more alert messages to be communicated to the delivery agent based on the determination that the driving events data has reached the one or more event thresholds.

12. A method for delivering retail items comprising:
by a control circuit of a retail container, the retail container configured to store one or more retail items for delivery by a delivery agent:
identifying the one or more retail items based on item identifiers associated with one or more tags read by a tag reader of the retail container;
determining, based on item characteristics of the one or more retail items, whether driving events during the delivery of the one or more retail items are to be evaluated; and
receiving driving events data from one or more sensors coupled to the control circuit over a time period of the delivery when the driving events are to be evaluated.

13. The method of claim 12, further comprising receiving locational data from a tracking system of the retail container; and determining whether a deviation from at least one predetermined delivery route has occurred based on the driving events.

14. The method of claim 12, further comprising:
determining whether the driving events data has reached one or more event thresholds each corresponding to a respective one of the item characteristics of the one or more retail items; and
associating each of the driving events data that reached the one or more event thresholds with the driving events relative to the time period.

15. The method of claim 12, further comprising:
subsequent to the receiving of the driving events data, determining whether a vehicle preformed an unscheduled stop at an unscheduled stop location during the delivery of the one or more retail items, wherein the driving events comprise the unscheduled stop;
receiving a container open data from a first sensor of the one or more sensors, wherein the driving events data comprises the container open data;
receiving subsequent reads of the one or more tags in response to the receiving of the container open data; and
determining whether the one or more retail items have been tampered with based on the unscheduled stop location during the delivery and based on the subsequent read of the one or more tags.

16. The method of claim 12, further comprising disabling at least one sensor of the one or more sensors coupled to the retail container from measuring the at least one of acceleration or vibration in response to the determining that the driving events during the delivery are not to be evaluated.

17. The method of claim 13, further comprising communicating with a thermal system configured to provide at least one of heating or cooling of the one or more retail items; and adjusting a temperature of the retail container via the thermal system.

18. The method of claim 12, further comprising accessing a cloud-based storage system configured to at least store item identifiers associated with the one or more retail items.

19. The method of claim 12, further comprising receiving and transmitting data wirelessly with at least one external device separate from the retail container via a device interface of the retail container.

20. The method of claim 19, wherein the device interface is operatively coupled to the at least one external device via a blockchain network, and further comprising storing, by at least one of: a memory of the retail container and a blockchain ledger, at least one of the item identifiers associated with the one or more tags, the one or more retail items associated with the item identifiers, and the driving events data.

21. The method of claim 12, further comprising:
determining whether the driving events data has reached one or more event thresholds each corresponding to a respective one of the item characteristics of the one or more retail items; and
causing one or more alert messages to be communicated to the delivery agent based on the determining that the driving events data has reached the one or more event thresholds.
